(19) United States
(12) Patent Application Publication
(10) Pub. No.: US 2016/0310770 A1
(43) Pub. Date: Oct. 27, 2016

(54) SYSTEM FOR PROTECTING AN OBJECT FROM FIRE

(71) Applicant: INFERNOSHIELD PTY LTD, Queensland (AU)

(72) Inventors: Andrew David HUNTER, NEW SOUTH WALES (AU); David John PROUD, QUEENSLAND (AU)

(21) Appl. No.: 15/136,468

(22) Filed: Apr. 22, 2016

Related U.S. Application Data
(63) Continuation-in-part of application No. PCT/AU2014/050299, filed on Oct. 22, 2014.

(30) Foreign Application Priority Data
Oct. 22, 2013 (AU) 2013904068

(51) Int. Cl. A62C 5/02; A62C 2/00; A62D 1/02

(52) U.S. Cl. CPC A62C 5/022; A62D 1/0071; A62C 2/00

(57) ABSTRACT

A method and system for protecting an object from fire are provided. The system comprises a composition including water, a solid particulate material, and a foaming agent, the composition being aeratable to form an aerated slurry, and an apparatus to aerate the composition to form the aerated slurry and to apply the aerated slurry to the object. Upon application, the aerated slurry forms a thermally-insulating layer adapted to substantially cover a surface of the object, thereby protecting the object from fire damage. The thermally-insulating layer is further adapted to dry on the surface of the object, and whereby the thermally-insulating layer is removable from the surface of the object by application of water.

### CROSS-REFERENCE TO RELATED APPLICATIONS

This application is a continuation-in-part of currently pending PCT Application No. PCT/AU2014/050299 entitled “FIRE PROTECTION COMPOSITION, USE THEREOF, AND METHOD OF PRODUCING AND APPLYING SAME” filed Oct. 22, 2014, which further claims benefit of Australia Patent Application 2013904068 filed Oct. 22, 2013, each of which is herein incorporated by reference in its entirety.

### BACKGROUND

1. Field of the Invention

The present invention relates to a system for protecting an object from fire. The system would typically include a composition which, when applied to a surface, provides a heat insulation layer and/or an oxygen barrier on the surface of the object that is capable of providing protection from fire. The present invention also relates to the use of the composition as a fire barrier, fire extinguisher and/or fire retardant. In addition, the present invention provides a process for preparing the composition; an apparatus for applying the composition to the object; and a method of removing the composition from the object.

2. Description of the Related Art

Forest fires (or bush fires) have been responsible for the destruction of property and loss of life in many parts of the world. There have been numerous methods, technology and management techniques developed to try to prevent, or at least reduce such loss. However to date many parts of the world are still subject to the devastating effects of forest fires on a frequent basis.

One method of preventing forest fires is to regularly conduct controlled burns to prevent the build-up of decomposing vegetation, which can be a fuel source for forest fires. The idea being that the controlled burns prevent the build-up of the fuel source and therefore lessen the intensity of future forest fires. However, it has been shown that regular burning does not prevent fires altogether. There is also a significant drawback associated with excessive greenhouse gas emissions that result from regular controlled burns.

Another safety measure is to dowse property and vegetation with water when a forest fire is detected in the vicinity. However, during intense forest fires, water does not function as a significant fire retardant and evaporates quickly as soon as the temperature surrounding the property increases. It is also difficult to locate sufficient quantities of water to efficiently dowse a property.

Accordingly, there is a need for a method of protecting property and/or the vegetation surrounding a property which may be at risk of being destroyed or damaged by forest fires.

Though forest fires have been discussed, this invention could apply to any type of fire or other heat source. For example, fires are also a major hazard in work areas that include highly flammable elements such as for example engine rooms on ships, oil rigs, refineries and other industrial and semi-industrial environments. If, for example, electrical maintenance is being conducted in such a work area, there is a significant risk that an electrical spark could ignite flammable material within the work area and cause a potential harmful and sometimes fatal fire situation.

Accordingly, there is also a need for a method of reducing the risk of fire in hazardous work environments.

### SUMMARY

In accordance with a first aspect of the present invention, there is provided a system for protecting an object from fire, the system comprising:

a composition including water, a solid particulate material and a foaming agent, the composition being aeratable to form an aerated slurry;

an apparatus operable by a user to aerate the composition to form the aerated slurry and to apply the aerated slurry to the object,

wherein upon application, the aerated slurry forms a thermally-insulating layer adapted to substantially cover a surface of the object, thereby protecting the object from fire damage,

the thermally-insulating layer being further adapted to dry on the surface of the object, and whereby the thermally-insulating layer is removable from the surface of the object by application of water by the user.

In accordance with a second aspect of the present invention, there is provided a method of protecting an object from fire, the method comprising the steps of:

preparing a composition including water, a solid particular material and a foaming agent;

aerating the composition to form an aerated slurry by way of an aeration apparatus; and

applying the aerated slurry to the object by way of an aeration apparatus to form a thermally-insulating layer adapted to substantially cover a surface of the object, thereby protecting the object from the fire.

There is also disclosed herein a thermal insulating layer that may be applied to a surface, wherein the thermal insulating layer is prepared from a composition including water and a solid particulate material suspended within the composition.

In one form, the composition further includes a foaming agent.

In one form, the foaming agent is chosen from one or more surfactants. The one or more surfactants may be chosen from ionic, non-ionic, anionic, cationic and/or zwitterionic surfactants. In one form, the surfactant is an anionic surfactant. In a further form, the surfactant is a sulphonated anionic surfactant.

In one form, the surfactant has a molecular weight of between 100 and 400 and in a preferred form, the surfactant has a molecular weight of between 200 to 300.

In one form, the solid particulate material has an average particle size of about 10 to about 200 μm. In a further form, the solid particulate material has an average particle size of about 20 μm to about 70 μm. In a further form, the solid particulate material has an average particle size of about 50 μm. In one form, the solid particulate material may be chosen from an inert and/or environmentally stable material. In a further form, the solid particulate material is chosen from a fire resistant and/or non-flammable material, and/or a solid particulate material which is stable at an elevated temperature of about 250° C.

In one form, the solid particulate material is selected from one or more or a combination of the following: calcium carbonate; sodium carbonate, kaolin, bentonite, dolomite, fly ash and silica sand. In one form, the solid particulate material is calcium carbonate.

In one form, the solid particulate material does not include Portland cement or calcium oxide, or the like.

In one form, the composition includes about 1.0 to 1.5 litres of water for every 1 kilogram of solid particulate material. In another form, the composition includes about 1.25 litres of water for every 1 kilogram of solid particulate material.

In one form, the composition includes about 0.1 to 5% volume of foaming agent. In another form, the composition includes about 0.5 to 2.5% volume of foaming agent. In a further form, the composition includes about 0.6 to 1.2% volume. In a further form, the composition includes about 0.75% volume.

In one form, the composition includes:

(a) about 20 wt % to about 70 wt % of water;

(b) about 30 wt % to about 80 wt % of the solid particulate material; and,

(c) about 0.1 wt % to about 2.0 wt % of the foaming agent.

In one form, the composition includes about 30 wt % to about 50 wt % water and in another form, about 35 wt % to about 45 wt % water.

In one form, the composition includes about 40 wt % to about 70 wt % of solid particulate material and in another form, about 55 wt % to about 65 wt % of the solid particulate material.

In one form, the composition includes about 0.3 wt % to about 1.7 wt % of the foaming agent and in another form, about 0.5 wt % to about 1.2 wt % of the foaming agent.

In one form, the thermal insulating layer is produced by first preparing the composition by adding the solid particulate material to the water together with the foaming agent. The resulting composition is then aerated, which produces an aerated slurry having a cellular foam-like structure. The aerated slurry may then be applied to a surface to thereby form the thermal insulating layer capable of insulating the surface from a heat source.

In one form, the composition has a density before aeration of about 1.3 Kg/l to about 1.9 Kg/l. In one form, the composition has a density before aeration of about 1.5 Kg/l to about 1.7 Kg/l.

In one form, the composition has a density after aeration of about 0.1 Kg/l to about 1.0 Kg/l. In one form, the composition has a density after aeration of about 0.4 to about 0.8 Kg/l.

In one form, the thermal insulating layer also provides an oxygen barrier between the surface and the atmosphere. In one form, the thermal insulating layer provides protection of the surface upon which it is applied from fire.

In one form, the composition after aeration has substantial adhesion properties, whereby the composition is able to stick, or adhere to various surfaces thereby forming the insulating layer of substantial thickness. The surfaces may be any typical surface such as those found on buildings and other man-made structures, as well as natural surfaces and vegetation.

In one form, the thermal insulating layer is at least about 5 mm to about 100 mm in thickness. In another form, the thermal insulating layer is at about 15 mm to about 50 mm in thickness.

In one form, the thermal insulating layer is allowed to dry on the surface. When dried, the thermal insulating layer is still capable of insulating the surface from a heat source.

In one form, the thermal insulating layer is water soluble and may be removed from the surface before drying, or after drying, with the application of water.

There is also disclosed herein a method of insulating a surface from a heat source, the method including:

preparing a composition including water and a solid particulate material and optionally a foaming agent;

aerating the composition to form an aerated slurry including a cellular foam like structure; and,

applying the aerated slurry to the surface to form a thermal insulating layer on the surface.

In one form, the thermal insulating layer is allowed to dry on the surface.

In one form, the aerated slurry is applied to the surface by spraying the aerated slurry on to the surface.

In one form, the surface may be chosen from any surface that may be subject to a heat source. In one form, the surface may be subject to the threat of a forest fire. In this form, the surface may be a surface on a living organism such as a plant, grass, tree or the like, or the surface may be on a non-living item such as a fence, house, wall, roof or other man-made structure. In this form, the thermal insulating layer applied to one or more of these surfaces provides protection of the one or more surfaces from fire.

In another form, the surface may be an area that may be in danger of catching fire, for example, an engine room on a ship, oil rig, refinery or other industrial area. In this form, the aerated slurry may be applied to all or part of the surfaces within the area to provide a thermal (i.e. heat) insulating layer to these surfaces and thereby decrease the risk of a fire commencing in that area.

There is also disclosed herein an apparatus for applying the aerated slurry to a surface to provide a thermal insulating layer, the apparatus including a dispenser for spraying the aerated slurry on to the surface.

In one form, the apparatus further includes a containment portion for containing the aerated slurry which is fluidly coupled to the dispenser. In one form, the composition including water, a particulate material and optionally a foaming agent may be provided in the container, whereby the container includes a mixing device and/or an inlet for delivering air into the containment portion to assist in producing the aerated slurry.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an arrangement showing a batch process for producing an aerated final composition for producing a thermal insulating layer, according to one or more embodiments; and

FIG. 2 depicts an arrangement for a continuous process for producing an aerated composition for producing a thermal insulating layer, according to one or more embodiments;

FIG. 3 shows a graph of Test 1;

FIG. 4 shows a graph of Test 2;

FIG. 5 shows a graph of Test 3;

FIG. 6 shows a graph of Test 4;

FIG. 7 shows a graph of Test 5; and

FIG. 8 shows the results of the Tests 3, 4 and 5 on a single graph.

### DETAILED DESCRIPTION

The present invention relates to a system for protecting an object from fire. The system would typically include a composition, which when applied to a surface, provides a heat insulation layer and/or an oxygen barrier on the surface of the object that is capable of providing protection from fire. The present invention also relates to the use of the composition as a fire barrier, fire extinguisher and/or fire retardant. In addition, the present invention provides a process for preparing the composition; an apparatus for applying the composition to the object; and a method of removing the composition from the object.

In certain embodiments of the present invention, a thermal insulating layer may be applied on a surface of an object, whereby the thermal insulating layer may then act as a thermal barrier protecting the surface from a heat source. In addition, the thermal insulating layer can act as an oxygen barrier, such that the surface is not supplied with sufficient oxygen to form a combustion reaction. Individually and in combination, providing a thermal insulating layer and/or an oxygen barrier provides that a surface can be significantly protected in the instance of a fire, be it a forest fire, or a localized fire, or the like.

In certain embodiments, the thermal insulating layer is provided on a surface by applying an aerated slurry. The aerated slurry is made up of a composition including water, solid particulate material and optionally a foaming agent. This composition is then formed into the aerated slurry by passing air (or another gas) into the mixture and forming a thick foam-like composition with gas bubbles, so as to form a cellular foam-like structure and the solid particulate material incorporated within the walls of the cellular foam like structure and thereby suspended throughout. The cellular foam-like structure of the aerated slurry allows the composition to be applied to a surface and form a thermal insulating layer, as the cellular foam-like structure is maintained for an extended period of time. Indeed, the cellular foam-like structure may be maintained for anywhere up to several days or weeks, which allows the thermal insulating layer to substantially dry and maintain the cellular foam-like structure and its heat insulating and/or oxygen barrier characteristics.

In certain embodiments, the thermal insulating layer provided by the aerated slurry provides an evaporative cooling effect on the surface to which it is applied, at least until the water or liquid included in the thermal insulating layer has evaporated. Even beyond this stage, the thermal insulating layer, even when dried, continues to provide an insulating layer or oxygen barrier which protects the surface upon which it is applied.

In certain embodiments, the gas used to aerate the composition to produce the aerated slurry may be selected from air, or any other suitable gas. In certain embodiments, it is preferable the gas does not substantially react with the components of the composition.

In certain embodiments, the gas used to aerate the composition to produce the aerated slurry may be introduced via a compressor, however, in an alternative form, the gas may be introduced by delivering the gas into the suction side of a pump that is pumping the composition as herein described. This requires the pump to pump gas as well as slurry, however, this removes the need for a compressor. This method may cause the pump to lose suction, necessitating re-priming of the pump if it has been stopped for a period of time. This can be overcome by fitting a recirculation valve after the pump, so that instead of starting and stopping the pump, the pump is run continuously, and the recirculation valve used to divert the product between the delivery hose and the tank.

The solid particulate material may be chosen from any suitable material. It is advantageous that the solid particulate material has an average particle size that enables the particles to be held in suspension within the aerated slurry and particularly when in the form of a cellular foam-like structure. A suitable particle size may be an average particle size of about 10 to 200 μm. In certain embodiments, the solid particulate material has an average particle size of about 20 μm to about 70 μm and in some instances about 50 μm.

The solid particulate material may be chosen from an inert and/or environmentally stable material. It may also be advantageous to choose the solid particulate material from a fire resistant or non-flammable material. In certain embodiments, the solid particulate material is selected from one or more or a combination of the following: calcium carbonate; sodium carbonate, kaolin, bentonite, dolomite, fly ash and silica sand. In a preferred form, the solid particulate material is chosen from calcium carbonate.

The foaming agent may be chosen from any suitable foaming agent and may include a surfactant. In certain embodiments, the surfactant is chosen from ionic, non-ionic, anionic, cationic and/or zwitterionic surfactants.

In certain embodiments, the surfactant is an anionic surfactant. As used herein, the term anionic surfactant refers to a surfactant containing anionic functional groups, such as sulphate, sulphonate, phosphate, and carboxylates. Anionic surfactants include alkyl sulphates such as ammonium lauryl sulphate, sodium lauryl sulphate (SDS, sodium dodecyl sulphate, another name for the compound) and alkyl-ether sulphates sodium laureth sulphate, also known as sodium lauryl ether sulfate (SLES), sodium myreth sulfate, docusates including dioctyl sodium sulfosuccinate, perfluorooctanesulfonate (PFOS), perfluorobutanesulfonate, linear alkylbenzene sulfonates (LABs), alkyl-aryl ether phosphates and alkyl ether phosphates, carboxylates including alkyl carboxylates, such as sodium stearate; sodium lauroyl sarcosinate and carboxylate-based fluorosurfactants such as perfluorononanoate, perfluorooctanoate (PFOA or PFO).

In one preferred form, the surfactant selected as the foaming agent is a sulphonated anionic surfactant. In a further preferred form, the surfactant has a molecular weight of between 100 and 400 and in a more preferred form, a molecular weight of between 200 to 300.

The composition, in one form, may be prepared by mixing about 1.0 to 1.5 litres of water for every 1 kilogram of solid particulate material and including about 1 to 5% volume of foaming agent. In a specific embodiment, the composition includes about 1.25 litres of water for every 1 kilogram of solid particulate material and including about 2.5% volume of foaming agent.

Once the aerated slurry is applied to a surface in sufficient quantity, the aerated slurry substantially covers the surface, providing a thick insulating layer which is able to act as a thermal insulating layer, or thermal barrier, thereby protecting the surface from a heat source. In certain embodiments, the thermal insulating layer is at least 5 mm thick. In a preferred embodiment, the thermal insulating layer is at least 15 mm thick.

The thermal insulating layer provides a thermal barrier as soon as it is applied to a surface. At this time, the thermal insulating layer may also provide a barrier to oxygen from the surface. Once the aerated slurry dries, the thermal insulating layer remains in place on the surface and continues to act as a thermal barrier and/or a barrier to oxygen.

It is also advantageous that the thermal insulating layer is water soluble and may be removed from the surface once applied and even after drying with the application of water. Importantly, the thermal insulating layer may be removed without damaging the surface on which it is applied on to. This allows a user to apply the layer to a house, for example as a fire approaches, and later wash the layer off the house, i.e. after the fire has passed and been extinguished.

The ease of applying the aerated slurry to form a thermal insulating layer on a surface provides that the present invention may be used in many different applications.

It is envisaged that the present invention may be used to protect vegetation and/or man-made structures or other objects in the event of forest fires, industrial fires or the like. In one embodiment, the aerated slurry may be applied to surfaces such as grassland, vegetation and other plants as well as man-made structures such as fences, houses, sheds, barns and vehicles providing a layer of about 5 mm to 20 mm on all surfaces. The resulting thermal insulating layer protects the surfaces of the vegetation and the man-made structures, thus providing a barrier to heat from the forest fires, for example, and also providing a barrier to oxygen which significantly hinders the combustion of the vegetation or man-made structure.

In particular, it has been surprisingly found that when the aerated slurry as herein described is applied to a structure such as a house, garage, shed or barn, the aerated slurry fills any cavities found in the structure such as around doors, windows and eaves, as well as providing a protective layer over the remainder of the surface of the structure. By filling the cavities, it was found that the aerated slurry reduced the egress of any fire into the interior of the structure from a fire impacting on or located adjacent the structure. As a result, the cavity-filling effect of the aerated slurry, when applied to a structure, significantly reduces the ability of a fire to penetrate into the interior of a structure or building, which thereby increases the fire resistance of the structure, object or building significantly.

Another environment over which the aerated slurry may be provided is in work areas or the like that may have an increased risk of fire breaking out, such as boat engine rooms, workshops, oil rigs, mines, or other industrial environments. Quite often, maintenance work in such environments requires electrical and/or welding or other maintenance equipment, which could increase the risk of fire in those areas. In such an instance, the aerated slurry may be applied to the various surfaces in that environment, which thereby provides a thermal insulating layer protecting the surfaces from a heat source, as well as providing a barrier to oxygen. In such an embodiment, a thermal insulating layer with a thickness of about 30 mm to about 100 mm may be required to provide sufficient thermal insulation. Once the aerated slurry is applied, the resulting thermal insulating layer provides an effective thermal barrier as well as an oxygen barrier to the surface upon which it is applied. If the thermal insulating barrier is subjected to heat from a fire in these situations, the evaporative effect of the water within the thermal insulating layer maintains the temperature of the surface upon which it is applied at close to 100° C.

The present invention will become better understood from the following example of a preferred but non-limiting embodiment thereof.

### Example 1

A composition including 25 litres of water, and 20 kilograms of calcium carbonate was mixed together with 600 millilitres of a foaming agent which was selected from a sulphonated anionic surfactant with a molecular weight of between 200 to 300. The subsequent mixture was then aerated until an aerated slurry was formed.

The aerated slurry was then applied to a wooden fence paling providing a layer of aerated slurry with an average thickness of 15 mm. Another control fence paling was also provided after which an oxyacetylene torch was applied to the surface of the fence paling including the layer of aerated slurry for a period of 45 seconds at a distance of 15 cm. The oxyacetylene torch was then applied to the control fence paling for 45 seconds at the same distance of 15 cm.

The aerated slurry was then washed off the first fence paling and the damage caused by the oxyacetylene torch on the two fence palings was compared. It was quite apparent that the fence paling including the aerated slurry was far less damaged from the heat emitted by the oxyacetylene torch than the second control fence paling.

### Example 2

Four (4) small-scale thermal tests were conducted using a four burner gas stove. Each ring can be individually adjusted. K type Thermocouples connected to a data logger were used to record temperatures against time.

### Determining Heat of Burner

To determine the heat being delivered by the gas burners, a cast iron pot was filled with 1 litre of water and placed on the burner. Only the two inner gas rings were lit.

The heat input into the water is given by:

Q=kAmΔT

Where:

Q=heat in Kj

K=specific heat=4.12 Kj/KgK for water

M=mass of water

ΔT=temperature rise

From this experiment, Q/A for the two inner rings only was found to be:

37 kW/m²

“Bushfire Attack Level” (BAL) is used to assess the intensity of radiant heat exposure as per AS3959 (Australian Standard AS3959) in relation to building practices. There are 6 levels, the highest being “BAL-FZ” which refers to the “Flame Zone”, and this corresponds to a heat load greater than 40 kW/m².

Accordingly, the gas burner approximates the radiant heat likely to be experienced in the worst bushfire (forest fire) conditions.

### Test 1

To determine the thermal properties of various formulations of compositions in accordance with embodiments of the present invention, a test was devised using a cast iron pot on a burner.

The pot was filled with approximately 1 litre of composition that had been aerated to form an aerated slurry with a foam like cellular structure, and heated using the inner two burner rings of the burner. This corresponded to a heat input of 37 kW/M².

Two thermocouples were embedded into the sample, one just above the base, and the other 12 mm higher. This provided a “thickness” of the thermal insulating layer formed by the aerated composition of 12 mm.

Test 1 used a composition with the following formulation:

| Solid | | | | | |
|---|---|---|---|---|---|
| particulate | | | | Un-Foamed | Foamed |
| matter | Water | Surfactant | Surfactant | Density | Density |
| % Slurry | % Slurry | Type | % Water | Kg/L | Kg/L |
| 60% | 40% | Anionic | 1% | 1.6 | 0.6 |

The solid particulate matter was chosen from calcium carbonate and the surfactant was selected from a sulphonated anionic surfactant with a molecular weight of between 200 to 300. The sample was initially wet in the “as-foamed” condition. During heating, the water within the formulation generates steam, and the sample expands. Whilst there is water within the sample, the temperature remains at around boiling point. It can be seen from the temperature traces below, that T2, the thermocouple nearest to the bottom of the pot, reaches 100 degrees soon after the experiment starts, however remains at this value for about 12 minutes.

T1, which is 12 mm higher than T2, also rises to about 100 degrees quickly, however takes about 28 minutes before the water is completely evaporated, and the temperature rises above 100 degrees.

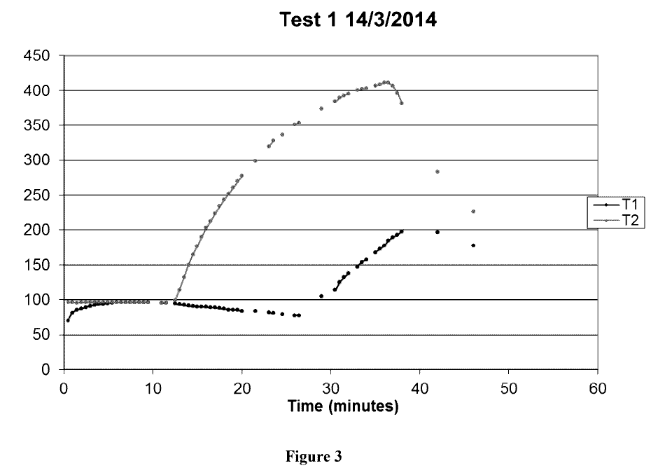

The test was continued until the temperature difference had approached a steady 175 degrees. A graph of the test is shown in FIG. 3.

The Specific Heat can be found as:

$$Q \text{/} A = \frac{- k Δ T}{I}$$

For this first test, k was found to be 2.5 W/mK.

### Test 2

The second test used the same method as Test 1, and used the following formulation:

| Solid | | | | | |
|---|---|---|---|---|---|
| particulate | | | | Un-Foamed | Foamed |
| matter | Water | Surfactant | Surfactant | Density | Density |
| % Slurry | % Slurry | Type | % Water | Kg/L | Kg/L |
| 60% | 40% | Anionic | 0.75% | 1.6 | 0.6 |

The solid particulate matter was chosen from calcium carbonate and the surfactant was selected from a sulphonated anionic surfactant with a molecular weight of between 200 to 300. In this test, the sample was initially wet in the “as-foamed” condition. During heating, the water within the formulation generates steam, and the sample expands. Whilst there is water within the sample, the temperature remains at around boiling point. It can be seen from the temperature traces below, that T2, the thermocouple nearest to the bottom of the pot, reaches 100 degrees soon after the experiment starts, however remains at this value for about 12 minutes.

T1, which is 12 mm higher than T2, also rises to about 100 degrees quickly, however takes about 28 minutes before the water is completely evaporated, and the temperature rises above 100 degrees.

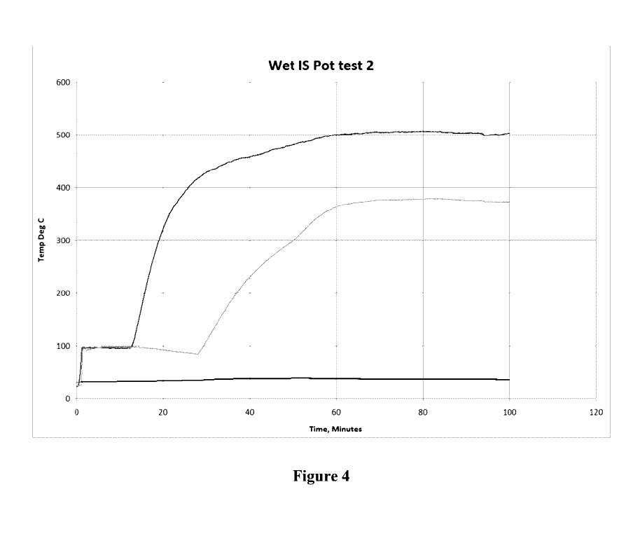

This test was continued until the temperatures had stabilised. The lower (near pot) temperature stabilised at about 507 degrees, while the upper temperature stabilised at 378 degrees. Note that this is not the surface temperature of the thermal insulating layer. A graph of the test is shown in FIG. 4.

The Specific Heat can be found as:

$$Q \text{/} A = \frac{- k Δ T}{I}$$

For this second test, k was found to be 3.4 W/mK.

### Test 3

In the following tests, the pot was not used. Instead, samples were placed directly above the burners, and the temperature of a backing plate of aluminium was logged.

A composition that had been aerated to form an aerated slurry with a foam-like cellular structure approximately 17 mm thick was applied to a piece of 3 mm aluminium, inverted and placed on the burner. A steel mesh was used to support the sample.

The below figure shows the temperature trace at the top surface of the aluminium. It can be seen that the temperature rise slows around 100 degrees, corresponding to the evaporation of the water from the sample. Thereafter, the temperature rises until a steady equilibrium is reached with the ambient air.

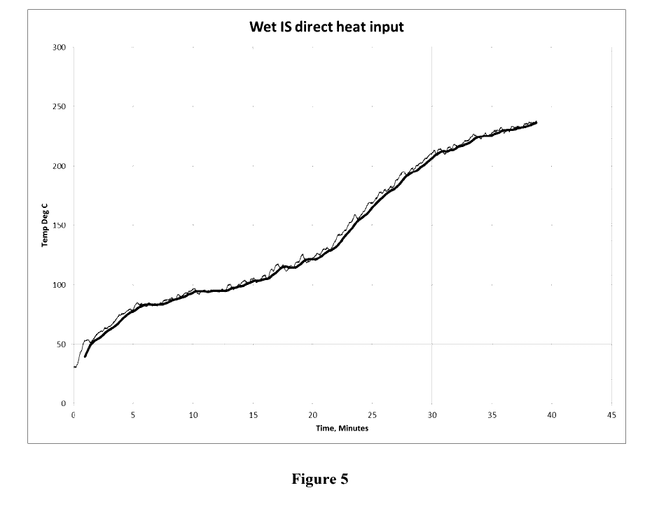

This test shows that it takes approximately 15 minutes to evaporate all the water from a 17 mm thick sample, and the maximum temperature recorded of around 230 degrees is reached after about 38 minutes. A graph of the test is shown in FIG. 5.

Note that the temperature was asymptotically reaching a steady-state temperature of approximately 280 degrees.

### Test 4

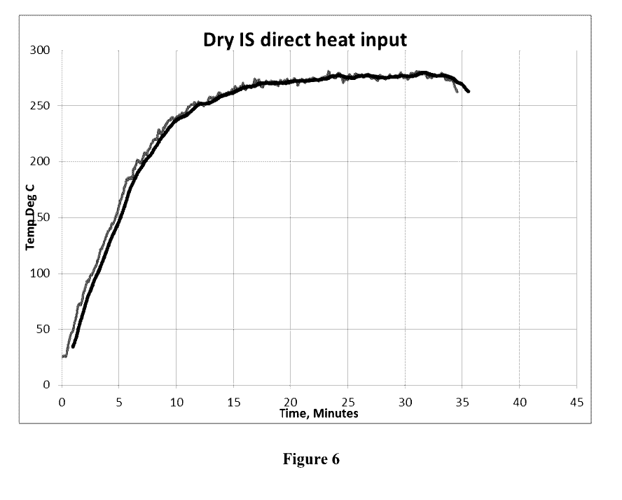

The sample used in the previous test 3 was allowed to cool overnight before the heat was re-applied. As such, this sample had been completely dried, and allowed to return to ambient temperature (approx. 24 degrees). Note that the sample had cracked in places, and was now only approximately 15 mm thick. The temperature rise was similar to the previous test, however there was no “dwell” at 100 degrees. The steady-state temperature was about 280 degrees. A graph of the test is shown in FIG. 6.

### Test 5

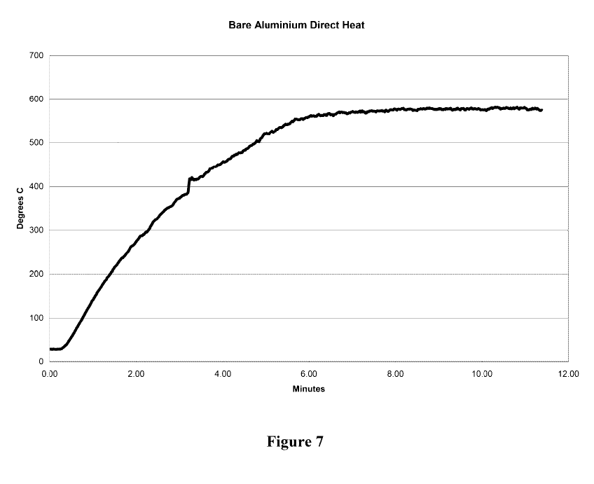

To provide a comparison, the aluminium panel used in the previous tests was placed on the burner. A graph of the test is shown in FIG. 7.

Note that the steady-state temperature was around 580 degrees, which corresponds to the melting point of some aluminium alloys. AT 400 degrees, some masking tape that was used to mount the thermocouple auto-ignited, causing the small increase in the temperature at this point.

### Comparison of Results

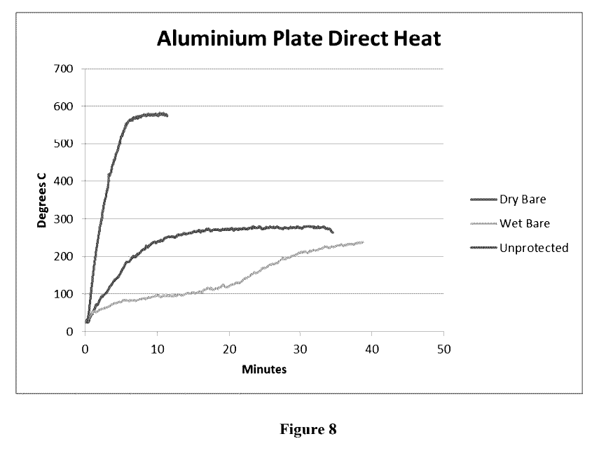

The following results of Tests 3, 4 and 5 are shown on the one graph (FIG. 8).

The results clearly demonstrate the effectiveness of the thermal insulating properties of both the wet or dry sample. The unprotected aluminium plate reaches approximately 580 degrees (melting point) after about 4 minutes, whilst a layer of the sample will limit the maximum temperature to approximately 280 degrees, and increase the time taken to reach this point.

### Mode of Preparation

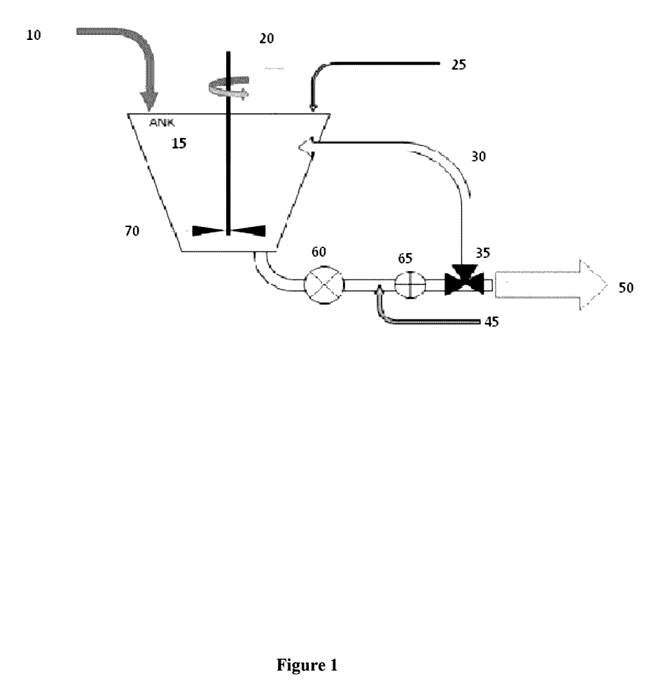

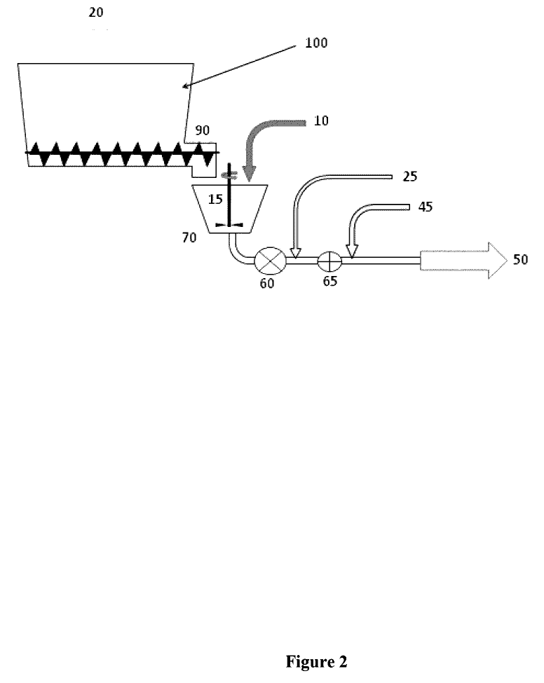

In certain embodiments, and referring to FIGS. 1 and 2, the aerated composition suitable for producing a thermal insulating layer as herein described may be prepared by first mixing the solid particulate material 20 and water 10 to produce a slurry. Since a very high amount of solid particulate material 20 is to be mixed into the water 10, the solid particulate material 20 should ideally be added slowly to the water 10 while thorough mixing using a stirrer 70 is taking place. Once all the solid particulate material 20 is mixed, the surfactant or foaming agent 25 can be added. Finally air (or another suitable gas) 45 can be injected into a pump 60 recirculating the composition, and the mixture blended finely using a mechanical emulsifier or pin mixer 65 to produce the foamed final product for producing a thermal insulating layer.

Once the slurry has been produced, it can be applied by aerial deployment, mobile vehicle delivery systems or hand-held devices. In turn, the slurry would therefore be pre-made and sold as a single complete product or multi-component product, or be made on site. For example, the slurry may be deployed using a mixing machine and hoses, or like a regular fire extinguisher.

In a preferred form, the thermally-insulating layer (formed from the slurry) is about 15 mm to 50 mm in thickness. The thickness and density of the layer required depends on the situation. For example, to provide a “firebreak” (discussed in further detail below), or to stop objects such as fences, vegetation, wood piles or timber framing from catching fire due to direct contact with the flames, a thin layer of low density foam, i.e. about 1 to 3 mm in thickness is required. In contrast, a thick layer of high density foam would be required to protect, for example, an oil tank from heating due to a prolonged oil fire in the surrounding area.

An application apparatus for the slurry preferably includes a dispenser for applying the aerated slurry on to the surface of the object by way of spraying. The application apparatus preferably further includes a containment portion for containing the aerated slurry, the containment portion being in fluid communication with the dispenser.

In one embodiment, a dispensing unit could be used. The dispensing unit may consist of metering, mixing and delivery systems. The dispensing unit is preferably capable of delivering approximately 80 litres/minute of un-foamed slurry, however, this rate can be reduced to slow the delivery rate and allow more mixing to occur. All ingredients can be individually adjusted to allow for various formulations. Preferably, the unit is approximately 2.3 m×0.6 m×0.9 m high to allow for transportation within a box trailer, or via a utility, or tray-top truck, or the like. Any and all augers and pumps are preferably electrically driven, and a generator may be required to power the unit if no mains power is available. The required generator size is nominally 14 kVA three phase. The minimum generator size required has not been determined.

This unit is preferably designed to manufacture the composition continuously, however such a unit can also be used in “batch” mode, where a one batch of product is made at a time. The maximum batch size is approximately 130 kg (200 litres). A “Mono” brand Progressive Cavity pump may be used to deliver the product which has a maximum flow rate of 80 litres per minute. A variable speed drive may be used to control this pump, allowing delivery rates to be reduced. This at least increases the time available to deliver a batch, and also at least increases the effectiveness of the emulsifier by increasing the time the product spends being mixed.

Trials have found that it is possible to add the surfactant directly to the blender without generating uncontrolled foam within the mixer. This means that batches can be made by accurately adding a fixed quantity of surfactant directly to the mix, rather than injecting the surfactant by pump into the delivery process. Hence, batches of un-foamed composition can be made in advance, and stored in drums for later deployment by more simple equipment.

Additionally, air can be added to the mix, and the batch cycled from the mixing tank through the pump and emulsifier, and back into the mixing tank. This allows much better blending of the foamed product, and air can be added until the required foamed density is achieved. Using this batching method, approximately 83 kg of foamed composition with a density of approximately 0.6 can be reliably achieved. This produces approximately 200 litres of final product.

Once the foamed product is made, it can be pumped directly onto surfaces to be treated, or pumped into tanks and transported to site. To deliver the product from these tanks, only a single pump, such as a progressive cavity or air driven diaphragm pump, is required.

Pre-mixing allows the product to be carefully manufactured under factory conditions, where QA controls and more advanced process controls can produce consistent product quality. This also results in less complex portable equipment required to be taken on site. The long-term stability of mixed or foamed composition is yet to be determined. The shelf-life of the blended product should be indefinite, however occasional re-blending may be required.

The composition can be pumped into a pressure vessel and then pressurised using compressed air. The compressed air will compress the composition, and the remaining void will allow sufficient compressed air to be stored to provide the power to force the product out through the delivery hose when required. Discharging this tank through a hose will allow the composition to expand. Trials were conducted using a portable sandblasting kettle with good results. It would also be possible to develop this system whereby un-foamed composition is mixed with the compressed air to generate the foamed final product.

This method has significant advantages as there are no pumps required, and the correct formulation can be pre-manufactured in a factory under controlled conditions. Operation is simple, and, along with the invention's other advantages, this could be a very simple ready to use fire “extinguisher”.

In addition, mixing acid with calcium carbonate (or similar) could produce a lot of CO₂ in a vigorous reaction. In this case, the acid would be fully consumed, and this method could be used instead of using compressed air to form the foam. Potentially a small amount of acid could be injected at the dispensing nozzle, so that the process becomes simplified. All the user will be required to do is pump the slurry, and the acid will generate the foam as the product leaves the nozzle. In the case of aerial deployment, this would mean that an aircraft could drop a thin layer of slurry which later reacts with a slow-release acid and foams after deployment. This method would significantly change the handling and delivery method. Foam systems usually inject the foaming agent into the nozzle as water is sprayed through it, and similarly, using the acid method, the acid would be injected into a stream of slurry. Alternatively, a pressure vessel could be filled with slurry and a small container of acid located inside such that when the container is inverted, the acid mixes and forms the foam within the container (this will become pressurised, the foam will only expand after the pressure is released).

In the case or urban fires, where gas cylinders may be subject to heat, this system could be used to quickly cover an exposed gas cylinder, thereby greatly increasing the available time for evacuation and reducing the risk of the cylinder exploding.

Conventional hoses can be used to transfer and deliver the composition. Nozzles can be used to generate a fan spray pattern. The size of the nozzle would depend on the pumping rate, and distance required to be reached. A high velocity of product may cause some product to splash off the surface, and can also remove already applied product. Trials have found that a steady movement will produce a uniform thickness, and the speed of movement will determine the applied thickness.

The composition and slurry of the system and method described above have somewhat similar properties to a dense foam extinguisher, however, as discussed above, one advantage is that the composition and slurry may be applied well in advance of a potential fire reaching the object. During this time, the composition and slurry will not lose its effectiveness. This allows the user to be away from the path of fire, as the application process does not need to happen immediately before or after the fire reaches the object. This also means that firefighters and members of the public can protect assets, and then evacuate, such that they are no longer exposed to the hazards of the fire itself. Conventional fire retardants or firefighting methods, in contrast, requires personnel to be in close proximity to the fire. Also exacerbating this issue is that getting access to fires in a timely manner is highly risky, especially in a rural setting where the distances to travel may be significant and the roads may only be trails. Fires often cut off access to and away from fires, and people have sometimes been caught on the roads.

Forest/bush fires for example, are unlike grass fires in that they are made up of essentially many small fires that form rapidly in a large area. It is therefore difficult for firefighters to be in many places at once, and thus with the composition and slurry as described above, they would be able to protect several structures before the fire arrives. The system and method described above are also relatively simple to operate and therefore do not necessarily have to be operated by a firefighter. This frees up the resources available to combat the fire itself.

Further, in most situations, firebreaks are formed to direct the fire away from sensitive areas, for example by backburning or by volunteers chipping away at vegetation, or a bulldozer clearing away vegetation to form a “break” thereby preventing a fire from spreading. The composition and slurry described above may also be utilised to form firebreaks hours or days in advance, in a more efficient and less time-consuming manner.

Additionally, it has been observed that in a house fire, for example, the fire will often find its way through small cracks or openings in the structure due to the strong winds generated by the fire. As such, flames and burning embers are forced into those small cracks or opening, which then ignite the materials within wall cavities and roof spaces, for example. Accordingly, the composition and slurry described above have the advantage that they can be applied in thick layers around locations where cracks or openings exist (for example, doorway vents), and are effective in preventing flames and embers from entering those cracks.

Another advantage of the composition and slurry described above is the environmental benefits. Known foam extinguishers and gel type additives typically use a relatively high amount of agent, some of which have bad health and environmental side effects. The composition and slurry described above use mainly an inert solid. The amount of additive per unit area is significantly less, and the toxicity of the additive is also typically less. If the solid particulate is calcium carbonate, it would help to break down clay soils and is thus a natural benefit to the typically poor soils found in most places where bushfires are a risk. If the slurry ends up in a surrounding stream or the like, it simply forms a layer of mud similar to other soil sediments.

As discussed above, FIG. 1 depicts an arrangement showing a batch process for producing the aerated final composition for producing a thermal insulating layer which, further includes a recirculation valve 35 that directs a portion or all of the flow exiting from the pin mixer 65 back to the tank 15 which effectively recycles the flow of the composition back through the pump 60 and pin mixer 35 thereby ensuring the cellular structure of the foamed composition is maximised, or at the ideal level before exiting 50 and used for its desired application.

In FIG. 2, like features have been provided with like reference numerals where FIG. 2 depicts an arrangement for the continuous process for producing the aerated composition for producing a thermal insulating layer. In addition to the features shown in FIG. 1, FIG. 2 further includes a large cement style container 100 which may is filled with the solid particulate material 20, and this is delivered via a hopper to the tank 10 together with water 10 to produce the composition on a continuous basis.

It is envisaged that additives may be added to the composition to increase adhesion, in particular when applied to slippery surfaces. It is also envisaged that additives may be added to the composition to increase strength (i.e. internal cohesion), so as to allow greater thicknesses to be achieved, reducing the risk of the composition shearing internally and sliding off.

It is further envisaged that additives may be added to the composition to increase applied longevity, i.e. to produce a permanent coating. For instance, in certain circumstances, it may not be necessary to wash the composition off from a building, object, or man-made structure after the threat of fire has left. In such circumstances, it would be desirable to provide a permanent coating which may be used to protect assets such as machinery sheds, pump houses, hay sheds, gas cylinders, fences and the like. This would have the advantage of providing a low-cost form of protecting such assets, and would also provide improved thermal insulation in normal weather conditions. Finally, it is envisaged that additives may be added to the composition to reduce the effects of spalling, i.e. the drying out of the composition due to the heat of the fire. As the composition dries, steam is released, and some shrinkage may occur. Additives to reduce spalling may be added so as to reduce shrinkage and to increase the porosity of the foamed composition.

1. A system for protecting an object from fire, the system comprising:
a composition including water, a solid particulate material and a foaming agent, the composition being aeratable to form an aerated slurry; and
an apparatus operable to aerate the composition to form the aerated slurry and to apply the aerated slurry to the object,
wherein upon application, the aerated slurry forms a thermally-insulating layer adapted to substantially cover a surface of the object, thereby protecting the object from fire damage,
the thermally-insulating layer being further adapted to dry on the surface of the object, and whereby the thermally-insulating layer is removable from the surface of the object by application of water.

2. The system according to claim 1, wherein the foaming agent is chosen from one or more surfactants selected from ionic, non-ionic, anionic, cationic and/or zwitterionic surfactants.

3. The system according to claim 1, wherein the solid particulate material has an average particle size of about 10 to 200 μm.

4. The system according to claim 1, wherein the solid particulate material is selected from an inert and/or environmentally stable material.

5. The system according to claim 1, wherein the solid particulate material is selected from a fire resistant and/or non-flammable material, and/or a solid particulate material which is stable at an elevated temperature about 250° C.

6. The system according to claim 1, wherein the solid particulate material is selected from one or more or a combination of the following: calcium carbonate; sodium carbonate, kaolin, bentonite, dolomite, fly ash and silica sand.

7. The system according to claim 1, wherein the solid particulate material does not include Portland cement or calcium oxide.

8. The system according to claim 1, wherein the composition includes:
(a) about 20 wt % to 70 wt % of water;
(b) about 30 wt % to 80 wt % of the solid particulate material; and,
(c) about 0.1 wt % to 2.0 wt % of the foaming agent.

9. The system according to claim 1, wherein the composition has a density before aeration of about 1.3 Kg/l to about 3.0 Kg/l.

10. The system according to claim 1, wherein the thermally-insulating layer provides an oxygen barrier between the surface of the object and the atmosphere.

11. The system according to claim 1, wherein the composition after aeration has substantial adhesion properties whereby the composition is able to adhere to the surface of the object.

12. The system according to claim 1, wherein the thermally-insulating layer is at least about 5 mm to 100 mm in thickness.

13. The system according to claim 12, wherein the thermally-insulating layer is about 15 mm to 50 mm in thickness.

14. The system according to claim 1, wherein the apparatus includes a dispenser for applying the aerated slurry on to the surface of the object by way of spraying.

15. The system according to claim 14, wherein the apparatus further includes a containment portion for containing the aerated slurry, the containment portion being in fluid communication with the dispenser.

16. The system according to claim 15, wherein the composition is provided in the containment portion together with a mixing device and/or an inlet for delivering air into the containment portion, so as to assist in producing the aerated slurry therein.

17. A method of protecting an object from fire, the method comprising the steps of:
preparing a composition including water, a solid particular material and a foaming agent;
aerating the composition to form an aerated slurry by way of an aeration apparatus; and
applying the aerated slurry to the object by way of an aeration apparatus to form a thermally-insulating layer adapted to substantially cover a surface of the object, thereby protecting the object from the fire.

18. The method according to claim 17, wherein the thermally-insulating layer is adapted to dry on the surface of the object.

19. The method according to claim 18, further including the step of removing the thermally-insulating layer from the surface of the object by application of water.

20. The method according to claim 17, wherein the aerated slurry is applied to the surface of the object by way of the aeration apparatus having a dispenser for spraying the aerated slurry on to the object.
